(19) United States
(12) Patent Application Publication
(10) Pub. No.: US 2024/0042875 A1
(43) Pub. Date: Feb. 8, 2024

(54) MARINE RECHARGEABLE POWER SOURCE SYSTEM

(71) Applicant: Kamil Podhola, Liberec (CZ)

(72) Inventor: Kamil Podhola, Liberec (CZ)

(21) Appl. No.: 17/882,645

(22) Filed: Aug. 8, 2022

(51) Int. Cl. B60L 53/30; B60L 58/24; B60L 53/51; B60L 53/52; B60L 53/54; B60L 53/66; B60L 53/80; B63B 35/44; H02J 3/38; G06Q 20/08

(52) U.S. Cl. CPC B60L 53/30; B60L 58/24; B60L 53/51; B60L 53/52; B60L 53/54; B60L 53/665; B60L 53/80; B63B 35/44; H02J 3/381; G06Q 20/08; B63B 2035/4453; B63B 2035/448; B63B 2035/446

(57) ABSTRACT

The invention relates to a marine rechargeable power source system (MPS) for water vessels at least partially electrically driven comprising a rechargeable power source, a source management system and a container which may be buoyant or nonbuoyant. The MPS may further comprise power transfer interfaces, power cables, thermal management systems, power sources, payment terminals, mobility devices. The MPS may provide data transmissions, may be a swappable power source and its container may be conveniently shaped. The MPS may be provided in a cloud-based communication system, a hydrogen gas powering system, a marine fuelling system and a modular system. An offshore swapping method using the MPS is proposed which can comprise a step of transferring power between the MPS and the water vessel at least partially electrically driven while stationary or in a motion. A swapping place may comprise charging apparatuses and power sources.

This application claims the benefit and priority of International Application No. PCT/IB2021/050160, filed 11 Jan. 2021 (11-01-2021) and is hereby incorporated by reference in its entirety.

### TECHNICAL FIELD

The invention relates to a marine rechargeable power source system for water vessels at least partially electrically driven.

### BACKGROUND ART

There is a wide range of water vessels at least partially electrically driven which are gaining popularity and are becoming more available for a wider range of consumers. They may comprise a rechargeable power source. They may have an improved ecological impact and may be a sustainable form of marine transportation. Many people and companies are attracted to them because they want to decrease their personal impact on the environment through transport.

WO 2019/180323 A1 (KONGSBERG MARITIME FINLAND OY [FI]) 26 Sep. 2019 (2019-09-26) discloses an autonomous barge for supplementing a first energy storage of a moving vessel, the autonomous barge comprising a second energy storage, moving means, wireless communication means, a controller and energy connection means.

The document fails to disclose a payment terminal comprised in or at least coupled with the autonomous barge and further it fails do discloses a shape conformity of the barge with the vessel.

US 2020/313254 A1 (GRAY STUART [US]) 1 Oct. 2020 (2020-10-01) discloses an energy storage system for a marine vessel. The energy storage system includes a battery pack and a storage container configured for housing the battery pack and other components and including an electrical interface for electrically coupling the battery pack to the vessel. The energy storage system also includes an air blast cooling system mountable to a first section of the container and for cooling the battery pack and an air conditioning system configured for cooling the other components.

The document fails to disclose a payment terminal comprised in or at least coupled with the energy storage system and further it fails to disclose a shape conformity of the energy storage system with the marine vessel. The document fails to disclose a swapping method concerning a rechargeable power source with a container shaped to convene to a water vessel.

US 2010/0071979 (Heichal) discloses an electric vehicle including a battery pack that can be exchanged at a battery exchange station. At the battery exchange station, an at least partially spent battery pack is exchanged for an at least partially charged battery pack. A battery bay is configured to be disposed at an underside of the electric vehicle. The battery bay includes a frame which defines a cavity. The cavity is configured to at least partially receive the battery pack therein. The battery bay comprises at least one latch rotatably pivoted about an axis substantially parallel with a plane formed by the underside of the vehicle. The latch is configured to lift, retain the battery pack at least partially within the cavity.

The document fails to disclose a marine rechargeable power source system with features as described ad GRAY STUART.

US 2006/0191463 (Little) teaches that battery packs have traditionally been placed on the deck of a marine vehicle, thus raising issues in terms of deck space and accessibility. It would have been obvious for Heichal to place the energy storage system on the deck since the deck is not submerged underwater.

US 2010/0071979 (Oh) teaches an air blast cooling system which provides water for cooling a battery pack and which is mounted on top of a battery container.

Little and Oh fail to disclose a marine rechargeable power source system with features as described ad GRAY STUART.

WO 2020/160899 A1 (SIEMENS AG [DE] 13 Aug. 2020 (2020-08-13) discloses a method of providing energy storage units to an energy storage system on a vessel adapted to use stored energy comprises receiving notification at a charging station onshore, of a user energy storage requirement; dispatching an autonomous vehicle from the charging station with one or more replacement energy storage units for the system: removing one or more used energy storage units from an operational location of the system; inserting the replacement energy storage unit at the same operational location of the system; and returning the used energy storage unit to the charging station.

The document fails to disclose a swapping method concerning a rechargeable power source with a container shaped to convene to a water vessel and fails to disclose a buoyant ISO container.

WO 2020/190147 A1 (HAF POWER SOLUTIONS AS [NO]) 24 Sep. 2020(2020-09-24) discloses an utonomous power battery exchange system for a marine vessel comprising self-driving battery assemblies, docking station onboard the marine vessel and charging station on shore, wherein the self-driving battery assemblies ae arranged for autonomous movement between the docking station and charging station or vice versa.

The document fails to disclose a payment terminal comprised in or at least coupled with the self-driving battery assemblies and further it fails to disclose a shape conformity of the self-driving battery assemblies with the marine vessel.

CN 112 009 302 A (SHENZEN FINE AUTOMATIC MACHINE CO LTD) 1 Dec. 2020 (2020-12-01) discloses an automatic wharf battery replacing system and method. The system comprises an energy supply station which is connected with a power grid and is used for accommodating an energy collection box and charging the energy collection box, an AGV transport vehicle which is used for transporting the energy collection box along a preset path, and transfer equipment used for transferring the energy collection box between the AGV transport vehicle and the ship. According to the automatic wharf battery replacing system and method, after the energy collection box is transferred to the AGV transport vehicle from the ship through transfer equipment, the energy collection box is transported to the energy supply station through the AGV transport vehicle to be charged; or when the AGV transport vehicle transports the energy collection box from the energy supply station to the transfer equipment, the AGV transport vehicle transfers the energy collection box to the transfer equipment; the transfer equipment transfers the energy collection box from the AGV transport vehicle to the ship, the operation of providing short-time power exchange for the pure electric ship during docking is completed, the energy supplementing time of the pure electric ship is greatly shortened, and the working efficiency of a wharf is improved through full-automatic operation.

The document fails to disclose a payment terminal comprised in or at least coupled with the energy collection box and further it fails to disclose a shape conformity of the collection box with the ship.

WO 2018/188271 A1 (GUANGZHOU XUANTONG JIENENG TECH COMPANY LIMITED [CN]) 18 Oct. 2018 (2018-10-18) discloses a water surface activity system allowing the quick swapping of a power battery on the water surface, comprising an electric boat body, a waterproof battery child boat, and a battery swapping station. The electric boat body is a boat body provided at the rear with a battery mount groove. The waterproof battery child boat is a rechargeable battery. The waterproof battery child boat is fittingly mounted on the electric boat body by being inserted into the battery mount groove, thus allowing the waterproof battery child boat and the electric boat body to form a quick unmount and swap structure. The battery swapping station comprises an infrastructural platform, a charger. battery swapping docking positions, and boat moving equipment. The battery swapping docking positions are docking positions on the infrastructural platform for use in the porting of the electric boat body for the unmounting or mounting of the waterproof battery child boat. The boat moving equipment is moving equipment used for moving and pushing the electric boat body to the battery swapping docking positions. A battery unmounting apparatus is provided on the electric boat body and/or the battery swapping station. This allows quick unmounting and replacement, is convenient to use, saves time, and effectively increases the usage rate of the electric boat body.

The document fails to disclose a payment terminal comprised in or at least coupled with the battery child boat and further it fails to disclose a shape conformity of the battery child boat with the electric boat body.

### DISCLOSURE OF INVENTION

The aforementioned deficiencies are therefore solved by the features of claims 1 and 10. In the dependent claims advantageous developments of a marine rechargeable power source and of an offshore swapping method according to the invention are given.

It is therefore the object of the present invention to propose the marine rechargeable power source system (MPS) for water vessels at least partially electrically driven comprising a rechargeable power source, a source management system, a power transfer interface, a buoyant or nonbuoyant container shaped to convene to the water vessel.

A further object is to propose the MPS further comprising a defined thermal management system.

A further object is to propose the MPS further comprising or at least coupled with a defined power source.

A further object is to propose the MPS further comprising a mobility device.

A further object is to propose the MPS further comprising or coupled with a payment terminal.

A further object is to propose the MPS provided in an offshore charging system.

A further object is to propose the MPS providing data transmissons.

A further object is to propose the MPS provided in a cloud-based communication system.

A further object is to propose the MPS provided in a modular system with defined modules.

A further object is to propoes the MPS with the conveniently shaped container and further comprising the payment terminal in an offshore swapping method.

Other and further objects will be explained hereinafter and will be particularly pointed out in the appended claims.

In a first aspect, the invention discloses a marine rechargeable power source system for a water vessel at least partially electrically driven.

In a second aspect, the invention discloses an offshore swapping method.

### BRIEF DESCRIPTION OF DRAWINGS

The invention will now be described by way of example. Only essential elements of the invention are schematically shown and not to scale to facilitate immediate understanding, emphasis being placed upon illustrating the principles of the invention.

FIG. 1 is a schematic perspective illustration of a marine rechargeable power source shaped to convene to a water vessel at least partially electrically driven (the container carrier stem superstructure type).

FIG. 2 is a schematic perspective illustration of another embodiment of a marine rechargeable power source shaped to convene to a water vessel at least partially electrically driven (the ferry boat stern superstructure type).

FIG. 3 is a perspective illustration of the embodiment shown in FIG. 1 with the carrier in port with a ramp open and coupled to onshore systems.

FIG. 4 is a perspective illustration of the embodiment shown in FIG. 2 at a ferry terminal with a ferry loading ramp open and coupled to onshore systems.

FIG. 5 is a schematic plan view of another embodiment of a marine rechargeable power source shaped to convene to a water vessel at least partially electrically driven (the ferry loading ramp type with tempering systems).

FIG. 6 is a schematic plan view of a another embodiment of a marine rechargeable power source shaped to convene to a water vessel at least partially electrically driven (the loading ramp type).

FIG. 7 is a block diagram of a source management system of an embodiment of a marine rechargeable power source according to the present invention.

FIG. 8 is a schematic perspective illustration of a marine rechargeable power source comprising a payment terminal, a power transfer interface and a plurality of rechargeable power sources; the marine rechargeable power source being shaped to convene to a water vessel at least partially electrically driven (the superstructure insertion type).

FIG. 9 is a schematic perspective illustration of another embodiment of a marine rechargeable power source shaped to convene to a water vessel at least partially electrically driven (the deck insertion type).

FIG. 10 is a schematic perspective illustration of another embodiment of a marine rechargeable power source shaped to convene to a water vessel at least partially electrically driven (the side hull insertion type).

FIG. 11 is a schematic perspective illustration of another embodiment of a marine rechargeable power source shaped to convene to a water vessel at least partially electrically driven (the side hull conveyor type).

FIG. 12 is a schematic perspective illustration of another embodiment of a marine rechargeable power source shaped to convene to a water vessel at least partially electrically driven (the bow of the ship type).

FIG. 13 is a schematic perspective illustration of another embodiment of a (mobile) marine rechargeable power source shaped to convene to a water vessel (a ferry boat) at least partially electrically driven (the stern hull/superstructure conveying/insertion type).

FIG. 14 is a schematic side view of a marine rechargeable power source comprising a buoyant container shaped to convene to a water vessel at least partially electrically driven (the stern of the ship type).

FIG. 15 is a schematic side view of another embodiment of a marine rechargeable power source comprising a nonbuoyant container shaped to convene to a water vessel at least partially electrically driven (the deck of the shipe type).

FIG. 16 is a schematic side view of another embodiment of a marine rechargeable power source comprising a mobile buoyant container shaped to convene to a water vessel at least partially electrically driven (the bow of the ship type).

FIG. 17 is a schematic perspective view of another embodiment of a marine rechargeable power source comprising a mobile buoyant container shaped to convene to a water vessel at least partially electrically driven (the outrigger hull/float/type).

FIG. 18 is a schematic plan view of another embodiment of a marine rechargeable power source comprising a mobile buoyant container shaped to convene to a water vessel at least partially electrically driven (the torpedo type).

FIG. 19 is a perspective view of another embodiment of a marine rechargeable power source provided in a modular system and comprising a mobile buoyant container shaped to convene to a water vessel at least partially electrically driven (the standardized float type).

FIG. 20 is a schematic a marine rechargeable power source provided in a modular system.

FIG. 21 is a perspective view of another embodiment of a marine rechargeable power source comprising a container shaped to convene to an over- or underwater vessel at least partially electrically driven (the multiple floats type).

FIG. 22 is a schematic perspective view of another embodiment marine rechargeable power source comprising a mobile container shaped to convene to a water vessel at least partially electrically driven (the conveyable type).

FIG. 23a is a perspective view of another embodiment of a marine rechargeable power source comprising a mobile container shaped to convene to a water vessel at least partially electrically driven (the stem ramp type).

FIG. 23b a perspective illustration of the embodiment shown in FIG. 23a with the vessel in port with a stern ramp open and coupled to onshore systems.

FIG. 24 is a schematic of a marine rechargeable power source provided in a cloud-based communication system comprising communication nodes.

FIG. 25 is a schematic of another embodiment of a marine rechargeable power source provided in an offshore charging system and providing a thermal management system including master and slave tempering loops.

FIG. 26 is a schematic side view of another embodiment of a marine rechargeable power source provided in an offshore charging system and providing a thermal management system consisting of a backbone and peripheral tempering loops and using offshore water as a thermal medium.

FIG. 27 is a schematic side view of a thermal management system of an air cooled wireless charging interface of a marine rechargeable power source.

FIG. 28 is a perspective illustration of a thermal management system of a liquid cooled wireless charging interface, the system using a thermal contact with an offshore water.

FIG. 29 is a schematic of a thermal management system of a charging cable which can be used in the proposed offshore charging system.

FIGS. 30a to 30c are schematics of an offshore swapping method.

FIGS. 31a to 31c are schematics of another embodiment of the offshore swapping method.

FIG. 32 is a schematic perspective view of another embodiment of a marine rechargeable power source comprising a mobile buoyant container shaped to convene to a water vessel at least partially electrically driven (the Navy's outrigger hull/float/type).

FIG. 33 is a schematic perspective view of another embodiment of a marine rechargeable power source comprising a mobile buoyant container shaped to convene to a water vessel at least partially electrically driven (the cruising yacht outrigger hull/float/type).

FIG. 34 is a functional frontal view of a coupling of another embodiment of a marine rechargeable power source comprising a mobile buoyant container shaped to convene to a water vessel at least partially electrically driven (the outrigger hull/float/type).

FIG. 35 is a schematic perspective view of another embodiment of a marine rechargeable power source comprising a mobile buoyant container shaped to convene to a water vessel at least partially electrically driven (the Navy's releasable torpedo type).

FIG. 36 is a schematic perspective view of another embodiment of a marine rechargeable power source comprising a mobile buoyant container shaped to convene to a water vessel at least partially electrically driven (the Navy's outrigger hull/float/type for an aircraft carrier).

### BEST MODE FOR CARRYING OUT THE INVENTION

The following detailed description shows the best contemplated modes of exemplary embodiments. The description is made for the purpose of illustrating the general principles of the invention, and in such a detail that a skilled person in the art can recognise the advantages of the invention, and can be able to make and use the invention. The detailed description is not intended to limit the principle of the presented invention, but only to show the possibilities of it.

The terms used in the claims and the specifications shall refer to their synonyms as well.

As used in the claims and the specification, the term, water vessel at least partially electrically driven” shall refer to manned and unmanned water vessels, and shall refer to overwater and underwater water vessels, and shall refer to toys and models and the like as well.

As used in the claims and the specification, the term “rechargeable power source” shall refer to rechargeable batteries, capacitors, hybrid sources, energy storage elements, and the like. The rechargeable power sources can be provided in various packages which can comply with different standards and parameters [e.g. can be modularly scalable/exchangeable, can be (salt) water resistant and tight], can provide various wired/wireless power/communication interfaces, etc.

As used in the claims and the specification, the term “source management system” shall refer to any possible technology [e.g. passive regulators, active regulators, management systems reporting the state of the source, protecting and thermally managing the source, etc.] and topology [e.g. centralized systems, distributed, modular, cloud-based management, etc.]. The source management system can ensure cell/module/pack balancing by various methods [e.g. wasting energy to a load, shuffling (balancing) energy between cells/modules/packs, reducing charging/discharging current, etc.]. Source protection can include various parameters [e.g. over-/undercurrent, over-/undervoltage, over-/undertemperature, overpressure, ground fault or leakage current detection. Protection can include external/internal switches (switching arrays) [e.g. relays, solid state devices, etc.]. The source management system can request the load [e.g. the offshore vessel] to optimalize [e.g. reduce, or cut off] power transfer parameters. Protection can include active or passive thermal management systems such as air tempering systems [e.g. using fins, fans, air heaters, etc.], liquid tempering systems [e.g. using cooling circuits which can include compressors, condensers, fans, thermostatic expansion valves, heat exchangers, dryers/separators. The systems can include or be coupled to various subsystems [e.g. the water vessel's at least partially electrically driven, etc.] such as power train cooling subsystems, refrigeration subsystems, battery cooling subsystems, heating, ventilation and cooling (HVAC) subsystems. Thermal management systems of the marine rechargeable power source may further include various conduits, valves, pipes, cooling pads, cooling loops, circulation pumps, reservoirs, etc. The source management system can provide monitoring and controlling various source parameters [e.g. cell/module/pack voltage(s), State of Charge (SoC), State of Health (SoH), State of Power (SoP), State of Safety (SoS), Maximum charge/discharge current, Energy delivered since last charge, Internal impedance of a cell, Charge delivered/stored, Total delivered energy. Total number of cycles, Temperature monitoring, etc. The source management system can provide internal communication and external communication [e.g. serial/paralel communication, CAN bus communication, wired/wireless networks communication, and combinations]. Communication can use various wired/wireless communication interfaces, lines, techniques and protocols.

As used in the claims and the specification, the term, “power transfer interface” shall preferably not exclusively refer to a power transfer interface wherein at least one said power transfer interface is selected from the group consisting of AC power transfer interfaces, DC power transfer interfaces, inductive power transfer interfaces, capacitive power transfer interfaces, magnetodynamic power transfer interfaces, or combinations thereof. The term, “inductive” shall also refer to resonant inductive, the term, “capacitive” shall also refer to resonant capacitive. The term, “magnetodynamic” shall preferably not exclusively refer to magneto-mechanical systems using translational and/or rotational motion of a magnetic element or arrays of magnetic elements to wirelessly transfer power.

As used in the claims and the specification, the term, “shaped to convene to the water vessel” shall preferably not exclusively refer to shapes and forms wich substantially correspond with the water vessel hull, superstructure or any part of it. The shape conformity can have an aerodynamical and/or hydrodynamical and/or functional aspect [e.g. to provide an easy swapping of the marine rechargeable power source at a swapping station, at a port, etc., to provide an access for maintenance, upgrading, etc.]. The shape conform marine rechargeable power source system can be composed of a plurality of (smaller) units which in an array can form a shape conformity.

As used in the claims and the specification, the term, “tempering systems” shall preferably not exclusively refer to cooling systems, heating systems, climatisation system, ventilation systems, etc.

As used in the claims and the specification, the terms, “onshore power source”, “offshore power source” shall refer to power transmission systems, power distribution systems and shall refer to mobile systems and shall refer to, “power grid” and the like as well.

As used in the claims and the specification, the term “motor generator” shall preferably not exclusively refer to electric energy generating systems using an electrical generator coupled with an engine (which can be a jet engine, an engine burning a hydrocarbon fuel, a gas generator, a turbine, etc.) and shall also refer to the term “power plant”, and the like, and shall also refer to mobile units, compact units, enclosed units, portable units, skid mounted units and shall also refer to thermal electric types and atomic types and shall also refer to floating and underwater types and shall also refer to power plants, power units comprising exhaust products (e.g. gases, fluids) treatments.

As used in the claims and the specification, the terms “mobile container”, “buoyant container”, “mobile buoyant container” shall refer to any type of containers with built-in, attached, detachably attached, etc. devices providing the containers with mobility, respective buoyancy and shall further refer to active and/or passive buoyancy control systems.

As used in the claims and the specification, the term, “payment terminal” shall preferably not exclusively refer to wired and/or wireless payment teminals, credit/debit card machines, payment terminals providing mobile payment which may include mobile browser-based payments, in-app mobile payments, mobile or wireless credit card readers, contactless mobile payments or mobile wallets. It shall further refer to any machine built to accept electronic card payments including point-of-sale (POS) terminals, credit cars terminals, Process Data Quickly (PDQ). It shall refer to software and hardware devices and systems which can have various architectures [e.g. with a computer/server and/or using peer-to-peer communication, etc.].

As used in the claims and the specification, the singular forms are intended to include the plural forms as well.

The term, “to couple” and derivatives shall refer to a direct or indirect connection via another device and/or connection.

The terms, “to comprise”, “to include”, “to contain” and derivatives specify the presence of an element, but do not preclude the presence or addition of one or more other elements or groups and combinations thereof.

The term, “consisting of” characterises a Markush group which is by nature closed. Single members of the group are alternatively useable for the purpose of the invention. Therefore, a singular if used in the Markush group would indicate only one member of the group to be used. For that reason are the countable members listed in the plural. That means together with qualifying language after the group, “or combinations thereof” that only one member of the Markush group can be chosen or any combination of the listed members in any numbers. In other words, although elements in the Markush groups may be described in the plural, the singular is contemplated as well. Furthermore, the phrase, “at least one” preceding the Markush groups is to be interpreted that the group does not exclude one or more additional elements preceded by the phrase.

The invention will be described in reference to the accompanying drawings.

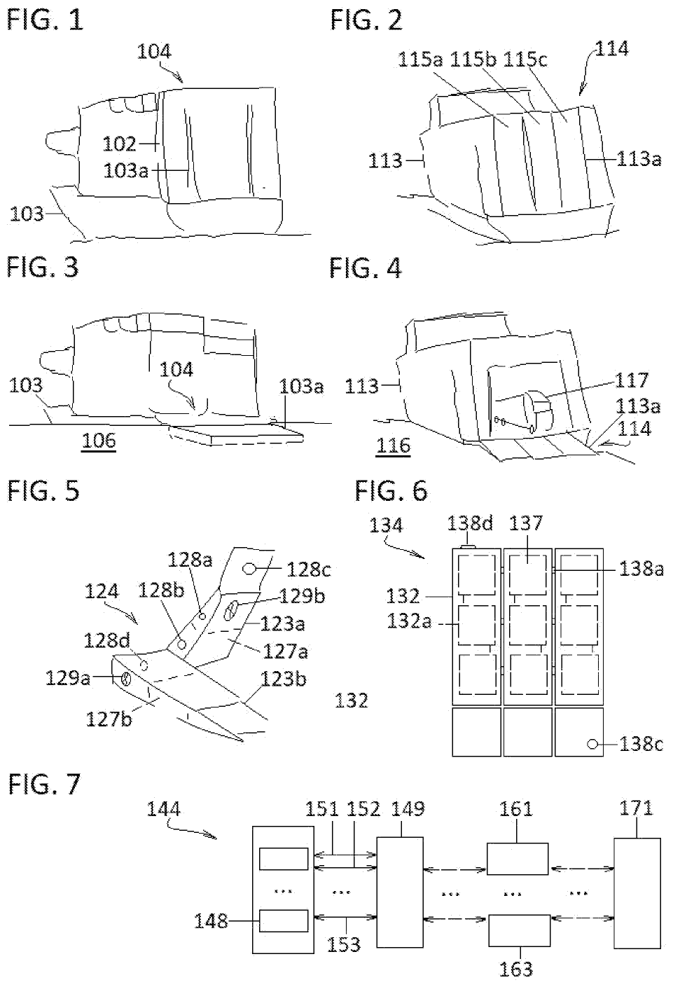

FIG. 1 is a schematic perspective illustration of a marine rechargeable power source (104) shaped to convene to a water vessel at least partially electrically driven (103) [which can be a container carrier]. The marine rechargeable power source (104) may comprise a rechargeable power source, a source management system, a (mobile) nonbuoyant container (102) a shape of which can convene to the vessel (103), e.g. it can be provided inside a (loading) ramp (103a) [or a side ramp or any other part of a superstructure and/or a hull] which can provide a shore connection of the ship (103) to load/unload not only the cargo but also the marine rechargeable power source (104) or its components [e.g. battery pack(s), battery modules (s) and/or cells], to provide a shore connection for a thermal management system, power connection, communication connection, etc. The marine source (104) can comprise at least one charging interface (not shown) or a plurality of charging interfaces connecting the rechargeable power source with the water vessel (103), providing a shore connection, interconnecting source packs, modules, etc.

The marine source (104) can comprise a payment terminal (not shown), a thermal management system and an array of solar cells (not shown) [which can be optionally provided on one or more exposed surfaces of the vessel (103) and/or of the marine rechargeable power source (104)].

The marine source (104) can (bidirectionally) provide power to each of the systems on the ship (103) [e.g. a traction power, an auxiliary power/heating, venting, cooling systems, etc./, power to a cargo if needed, etc.]. The marine source (104) can be dischargeable or rechargeable during a cruise and/or when the ship (103) being at anchor connected to a power source (not shown) [which can be an onshore power source, an offshore power source, etc.] The marine rechargeable power source (104) may comprise a mobility device which can be a ramp lifting system but also an (autonomous) mobilitty device enabling changing, swapping, etc. of individual components [e.g. battery modules, etc.] when the ship (103) being at a swapping place [e.g. for maintenance reasons, upgrading, swapping discharged battery packs, modules, etc.].

The rechargeable power source (not shown) can be banks of rechargeable capacitors and/or batteries. The source management system (not shown) can manage charging and/or discharging the rechargeable power source [it can comprise various circuit topologies including electrocomponents such as converters, inverters, voltage regulators, power factor corrections, rectifiers, filters, controllers, processors, etc.]. The (mobile) container (102) can be fabricated from any convenient material [e.g. steel, etc.] and can comprise any convenient mobile device which can be controlled by a convenient control system including a remote control. The charging interface [which can be used for charging/discharging the rechargeable power source and the water vessel at least partially electrically driven] can be an AC charging interface, a DC charging interface, an inductive charging interface, a capacitive charging interface, a magnetodynamic charging interface.

The payment terminal can be of any convenient type. The thermal management system can be of any air and/or liquid tempering systems [it can comprise ventilators, thermal exchangers, compressors, chillers, condensers, heaters, sensors, pumps, programmable controllers, thermal medium conducts, valves]. The array of solar cells (not shown) can be a solar panel mounted on the container (102) and coupled with the source management system.

FIG. 2 is a schematic perspective illustration of another embodiment of a marine rechargeable power source (114) shaped to convene to a water vessel at least partially electrically driven (113) [which can be a ferry boat and the marine power source (114) can be provided inside a ferry terminal loading ramp (113a)]. The marine rechargeable power source (114) may comprise a rechargeable power source [which can be provided in a form of a battery pack including one or more battery modules (115a, 115b, 115c), a source management system, a (mobile) nonbuoyant container [which can be shape conform to a loading ramp], a charging interface (not shown), a thermal management system [which can use offshore water as a thermal medium].

FIG. 3 is a perspective illustration of the embodiment shown in FIG. 1 showing the ship (103) with the ramp (103a) open e.g. while the ship (103) can be in port (106) which can provide an onshore power and communication connection (not shown) by means of a suitalbe wired and/or wireless power and/or communication interface, network, etc. The port (106) can be a swapping place providing a swapping possibility for any component and/or the entire marine source (104). The port (106) can provide connections for a thermal management system, charging/discharging power sources/loads, swapping facilities and installations, stocking possibilities for MPSs, conveying devices and systems, communication and management networks, etc. The marine source (104) can be recharged/discharged when the ship (103) can be loaded and/or unloaded with a cargo. The same applies to swapping first and second marine rechargeable power sources.

The charging interfaces [wired or wireless] can be provided in conformity with shore connection standards.

FIG. 4 is a perspective illustration of the embodiment shown in FIG. 2 showing the ferry boat (113) with ferry loading ramp (113a) open e.g. while the ferry (113) can be in a ferry terminal (116) which can provide an onshore power and communication connection (not shown) by means of a suitalbe wired and/or wireless power and/or communication interface, network, etc. The ferry terminal (116) can be a swapping place providing a swapping possibility for any component and/or the entire marine source (114). The ferry terminal (116) can provide connections for a thermal management system. The marine source (114) can be recharged/discharged when the ferry boat (113) can be loaded and/or unloaded [e.g. with vehicles (117)]. Similarly first and second marine rechargeable power sources can be swapped from/to the ramp (113a) while the ferry (113) can be in the terminal (116).

FIG. 5 is a detailed perspective view of a loading ramp which can be composed of a plurality of sections (123a, 123b) which can contain a conveniently shaped marine rechargeable power source (124) which can be composed of a plurality of rechargeable power sources (127a, 127b) [which can be battery packs, modules, hybrid sources, etc.] which can be interconnectable with compatible wired and/or wireless power transfer interfaces (128a, 128b) and power transfer interfaces for a shore connection (128c) and for a vessel connection (128d). The marine power source (124) may comprise a thermal management system which can include a fan (129a, 129b).

FIG. 6 is a schematic plan view of a marine rechargeable power source (134) comprising a conveniently shaped container (132) [which can be a loading ramp provided with separate and interconnected boxes (132a) containing rechargeable power sources (137) which can be interconnectable with compatible wired and/or wireless power transfer interfaces (138a) and power transfer interfaces for a shore connection (138c) and for a vessel connection (138d).

FIG. 7 is a block diagram of a source management system of an embodiment of a marine rechargeable power source (144) which can comprise a plurality of rechargeable power sources (148) [which can form a battery pack, a battery-capacitor pack, etc.], a monitoring and controlling module (149) which can mesure current (151), voltage (152), temperature (153), etc. and which may calculate various state components such as State of Charge (SoC) (161), Temperature Monitoring (163), etc. and a controller (171) [which can be a CAN bus (micro) controller, etc.].

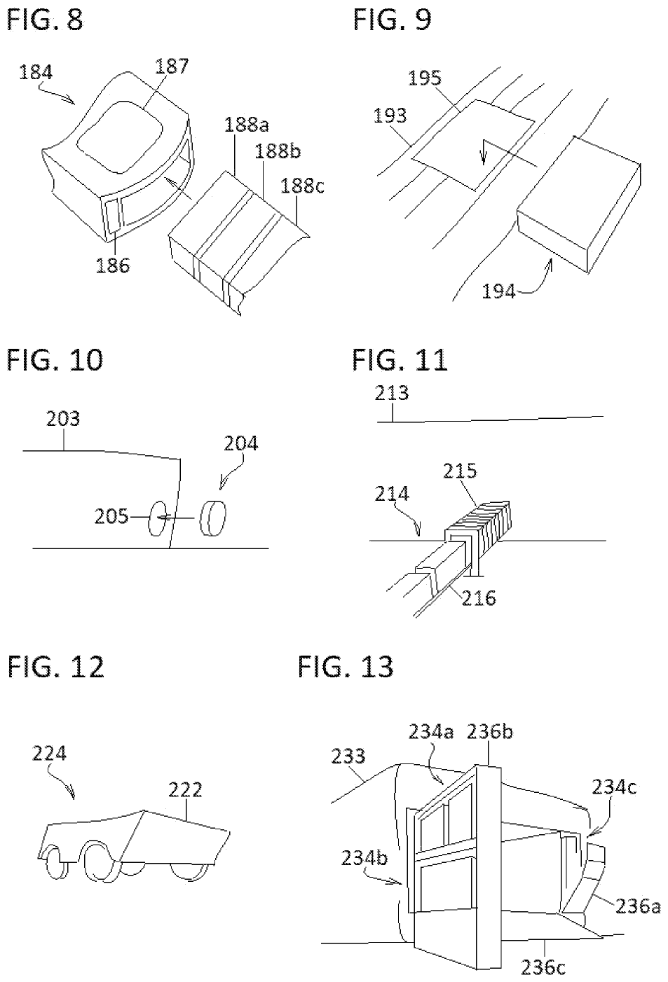

FIG. 8 is a schematic perspective illustration of a marine rechargeable power source (184) comprising a payment terminal (186) [which can include a processor, a memory, a communication module and interface, an antenna, etc.], a power transfer interface (187) [which can be a resonant inductive, resonant capacitive, resonant magnetodynamic or resonant electromagnetic power transfer interface/as tought in my pending patent application titled Wireless electromagnetic energy transfer system of International Application No. PCT/IB2021/054328/] and a plurality of rechargeable power sources (188a, 188b, 188n) [which can be battery modules, battery packs, hybrid sources, etc.]; the marine rechargeable power source (184) can be shaped to convene to a water vessel at least partially electrically driven (not shown).

FIG. 9 is a schematic perspective illustration of another embodiment of a marine rechargeable power source (194) shaped to convene to a water vessel at least partially electrically driven (193) [e.g. via a deck insertion slot (195)].

FIG. 10 is a schematic perspective illustration of another embodiment of a marine rechargeable power source (204) shaped to convene to a water vessel at least partially electrically driven (203) [e.g. via a side hull insertion slot (205)].

FIG. 11 is a schematic perspective illustration of another embodiment of a marine rechargeable power source (214) shaped to convene to a water vessel at least partially electrically driven (213) [e.g. via a mobile gangway (215) with a conveyor ramp (216)].

FIG. 12 is a schematic perspective illustration of another embodiment of a marine rechargeable power source (224) in a mobile amphibious container (222) [which can be an unmanned drone] shaped to hydrodynamically convene to a water vessel at least partially electrically driven (not shown).

FIG. 13 is a schematic perspective illustration of another embodiment of a (mobile) marine rechargeable power source (234a, 234b, 234c) shaped to convene to a water vessel (a ferry boat) at least partially electrically driven (233) [e.g. via a back hull/superstructure conveying/insertion which can use a loading ramp (236a), a loading (swapping) tower (236b) or any other convenient construction or system]. Alternatively there can be slots provided in the hull and/or the supersctructure of an electric vessel at least partially electrically driven to match conveniently shaped marine rechargeable power sources according to the invention which slots can be situated at any part of the vessel and in any orientation [e.g. horizontally under a ferry loading ramp (236c), etc. wherein a correspondingly arranged charging/discharging and/or swapping facilities can be provided onshore/offshore at a charging/swapping place; e.g. for the horizontally oriented slot; in that case a marine rechargeable power source according to the invention can be conveniently shaped to match a hull and/or a superstructure or its portion; e.g. as shown in FIG. 8]. Charging/discharging eventually swapping can take place during embarkation and disembarkation of the ferry (233).

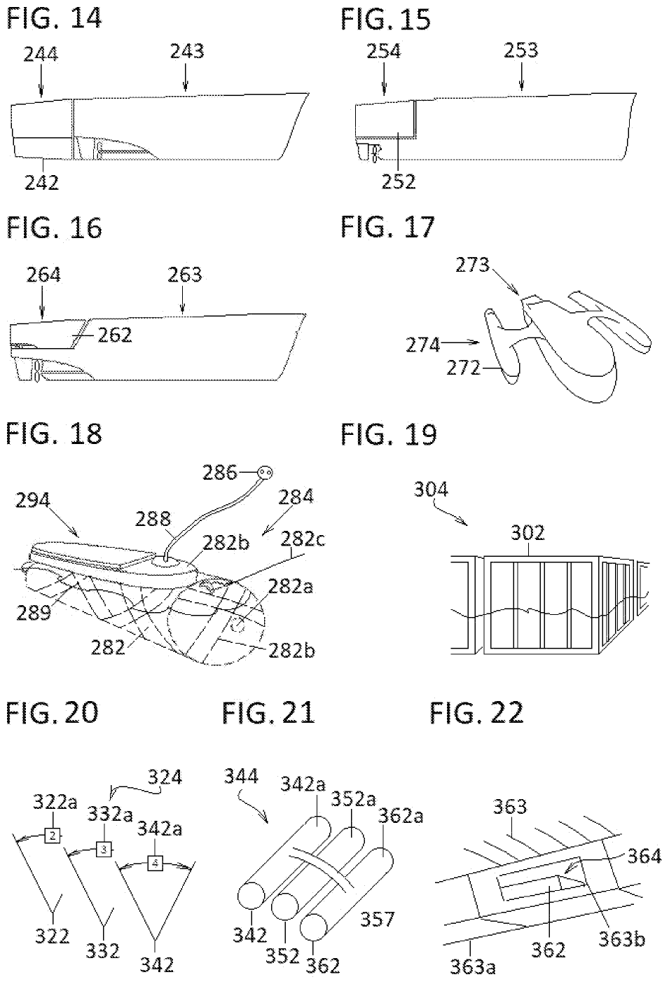

FIG. 14 is a schematic side view of a marine rechargeable power source (244) comprising a buoyant container (242) which can be shaped to convene to a water vessel at least partially electrically driven (243) and can be configured to be a swappable power source for the water vessel (243) [e.g. can comprise a functional/communication/shape compatibility, i.e. can comprise compatible power transfer interfaces, compatible communication interfaces, compatible rechargeable power sources, compatible source management systems, power cables, thermal management systems, etc.].

FIG. 15 is a schematic side view of another embodiment of a marine rechargeable power source (254) comprising a nonbuoyant container (252) which can be shaped to convene to a water vessel at least partially electrically driven (253) [the volume of the container (252) forming a part of the superstructure of the vessel (253) can be reduced into a mobile boat boarding ramp as shown in FIG. 1].

FIG. 16 is a schematic side view of another embodiment of a marine rechargeable power source (264) comprising a mobile buoyant container (262) which can be shaped to convene to a water vessel at least partially electrically driven (263).

FIG. 17 is a schematic perspective view of another embodiment of a marine rechargeable power source (274) comprising a mobile buoyant container (272) which can be shaped to convene to a water vessel at least partially electrically driven (273).

FIG. 18 is a schematic perspective view of a marine rechargeable power source (284) comprising a conveniently shaped mobile buoyant container (282) [which can contain a rechargeable power source (not shown) and which can be provided with a conduct (282a) of an ambient water (289) forming a part of a thermal management system, another part can be provided by an outer surface which can be in a contact with the ambient water (289) and which can include cooling bands (282b) with a coolant, etc.], a combined power transfer/charging interface (286) [which can be coupled to charge/discharge the rechargeable power source and/or a water vessel at least partially electrically driven (not shown) and/or to provide a power transfer between the rechargeable power source and the water vessel which power can be used to power an electric motor of the vessel and its auxiliaries], a power cable (288) [which can transfer power between the rechargeable power source and the vessel and/or between an external power source (not shown) and the rechargeable power source], and a power generator, e.g. an array of solar cells (294) [which can be mounted on a detachable upper part (282b) which can contain a source management system (not shown)].

A thermal management system can thermally manage the rechargeable power source and/or the power transfer interface (286) and/or the power cable (288) using air tempering systems, liquid tempering systems and liquid tempering systems using offshore water as a thermal medium. The marine rechargeable power source (284) can be configured to be a swappable power source for the vessel [e.g. can comprise the compatible interface (286), various compatible coupling devices (282c)/e.g. detachably attachable/, compatible communication interfaces (not shown), etc.].

FIG. 19 is a perspective view of another embodiment of a marine rechargeable power source (304) provided in a modular system and comprising a mobile buoyant container (302) shaped to convene to a water vessel at least partially electrically driven [e.g. the buoyant container (302) can have a modularly standardized ISO shipping container dimensions 8 ft (2.43 m) wide, 8.5 ft (2.59 m) high and 20 ft (6.06 m) or 40 ft (12.2 m) long]. The container (302) can comprise a rechargeable power source [e.g. a rechargeable battery pack, capacitor pack, hybrid pack, a hydrogen storage system, a hydrogen production system, an energy storage element], a wired/wireless charging interface, it can be water cooled in ambient water, etc. The buoyancy can be acchieved by various methods [e.g. floaters, a watertight container, an open frame-type container containing an MPS and buoyant contents/e.g. wooden logs/etc.]. The MPS (304) can be mobile, e.g. the container can be provided with a propelling system and navigation and fully automated [e.g. the mobility and navigation module can keep position at sea, follow, guide the MPS (304) to a ship, to a harbor, to a swapping place, etc.].

FIG. 20 is a schematic of a marine rechargeable power source (MPS) (324) which can comprise a container (322, 332, 342) shaped to convene to a water vessel at least partially electrically driven (not shown) [e.g. an upper surface (322a, 332a, 342a) can be curved and seized conformly to a hull of an under-/overwater vessel, a superstructure wherein a corresponding slot can be provided, etc.]. The MPS can be provided in a modular system wherein modules (322, 332, 342) can be scalable and/or exchangeable.

FIG. 21 is a schematic of a marine rechargeable power source (MPS) (344) which can comprise a (buoyant) container (342, 352, 362) shaped to convene to a water vessel at least partially electrically driven (not shown) [e.g. a round upper surface (342a, 332a, 342a) can be curved and seized conformly to a hull of an under-/overwater vessel, a superstructure, e.g. in its a diameter which can correspond to that of the vessel]. The MPS can be provided in a modular system wherein modules (342, 352, 362, 372) can be scalable and/or exchangeable [e.g. detachably attachable, coupled with a belt (357), etc].

FIG. 22 is a perspective view of another embodiment of a marine rechargeable power source (364) comprising a mobile container (362) shaped to convene to a water vessel at least partially electrically driven (363) comprising a conveying system [which can be a groove, a path (363a), etc. including a conveyor belt, rollers, etc. wherein the container (362) can be conveniently shaped to match the path (363a) providing slots (363b) for the container (362) to be inserted into a hull (or a superstructure) of the vessel (363)]. The view is taken from the vessel's (363) interior.

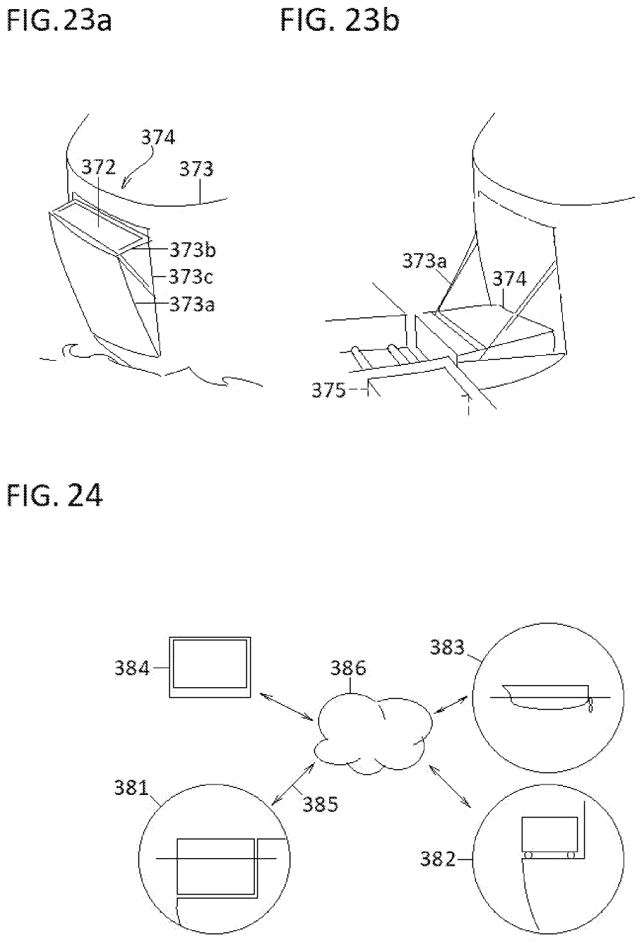

FIG. 23a is a perspective view of another embodiment of a marine rechargeable power source (374) comprising a mobile container (372) shaped to convene to a water vessel at least partially electrically driven (373) comprising a conveying system [which can be a ramp (373a) (shown in a half-opened position) including a cage (373b) wherein the container (372) can be conveniently shaped to match the cage (373b) providing an opening (363c) for the container (372) to be inserted into a hull (or a superstructure) of the vessel (373)]. The insertion opening (373c) can be provided from a stern, a bow a starboard, a port side, etc. The installation can be provided with convenient power transfer, communication wired/wireless interfaces (not shown), a thermal management system [including liquid tempering (i.e. cooling and/or heating) systems using offshore water as a thermal medium] which can thermally manage power transfer interfaces, power transfer cables, a rechargeable power source (not shown) inside the container (372), etc.

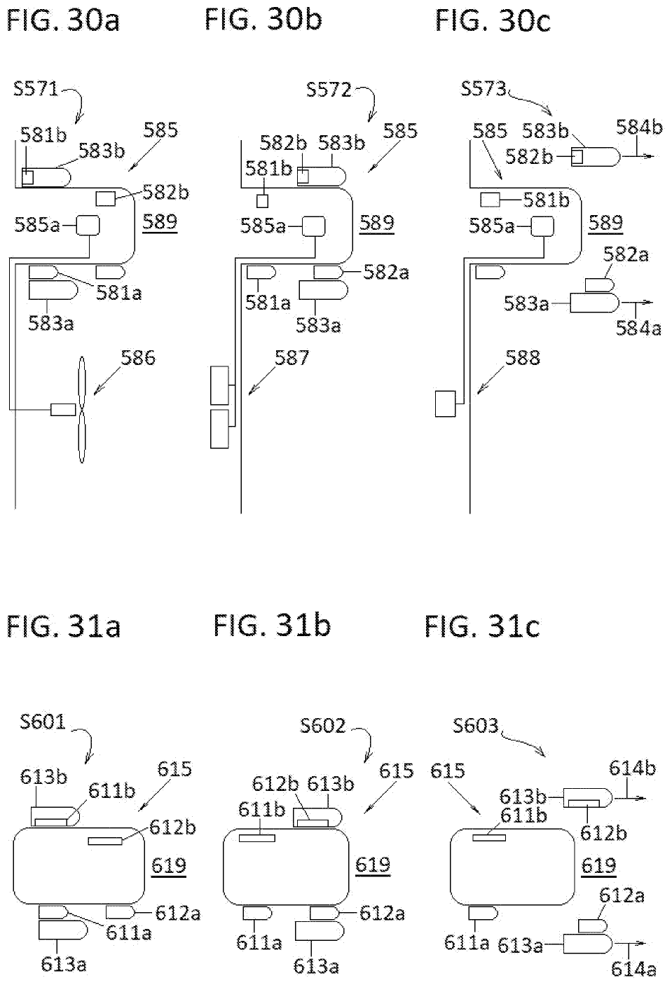

FIG. 23b is a perspective view of the embodiment of the marine rechargeable power source (374) shown in FIG. 23a with the bridge (373a) open so that the marine power source (374) can be coupled with a power source (375) [e.g. an onshore or offshore charging station, a (smart) power grid, etc.] or to be swapped in the proposed swapping method [e.g. as shown in FIGS. 30a to 31c].

Common Features of FIGS. 1 to 23b

Marine rechargeable power source systems can provide wired/wireless data transmissions in relation with charging and/or discharging rechargeable power sources and/or water vessels at least partially electrically driven and/or with power transfers between the water vessels and the rechargeable power sources. The data transmissions can be local [e.g. via charging interfaces, local wired/wireless networks] and distant [e.g. via power cables, satellite connections, telephone techniques, etc.]. The data transmissions can include underwater acoustic techniques. The systems can use any type of communication interfaces, lines, techniques and protocols.

FIG. 24 is a schematic of a marine rechargeable power source provided in a cloud-based communication system comprising communication nodes (381, 382, 383, 384) which can be an embodiment of a conveniently shaped buoyant marine rechargeable power source (381), another embodiment of a conveniently shaped nonbuoyant marine rechargeable power source comprising a mobile container (382), a water vessel at least partially electrically driven (383) and an operator (384).

The communictaion nodes (381, 382, 383, 384) can be in wired and/or wireless communication (385) with a cloud (386) which can store their data. The operator (384) can via the cloud (386) operate the communication system. Each communication node (381, 382, 383, 384) and the cloud (386) can have a different operator.

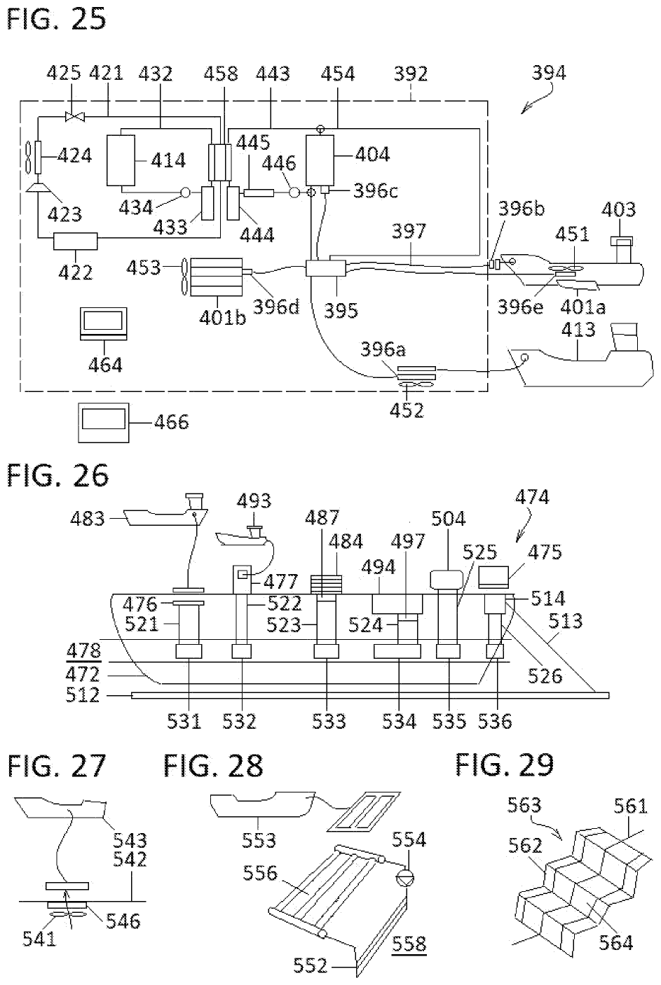

FIG. 25 is a schematic of another embodiment of a marine rechargeable power source (394) provided in an offshore charging system comprising water vessels at least partially electrically driven (403, 413), a (buoyant) container (392) shaped to convene to the water vessels (403, 413) [e.g. provided in standard ship dimensions] and a source management system, e.g. a combined wired/wireless (bidirectional) charger (395) [the source (battery) management system can directly control DC charging of a rechargeable power source (404) during AC charging, the charge control can be partly taken by an on-board charger responsible for converting AC current to DC] providing a wireless charging interface (396a) [which can be an inductive charging pad], a fast DC charging interface (396b), a DC charging interface (396c) for the rechargeable power source (404), another DC charging interface (396d) for second swappable rechargeable power sources (401b) provided by the MPS (394) [which can be configured as a swappable power source itself or which can comprise or be coupled with swappable power sources] and an electromagnetic charging interface (396e) for a first swappable rechargeable power source (401a) provided by the water vessel (403). The MPS (394) can provide a power generator (414) [which can be a (modularly configured) hydrogen power unit/which can include a hydrogen gas tank/providing fuel cells].

The MPS (394) can provide a thermal management system which can be a liquid tempering system which can include loops [a first loop (421) which can include a dryer/separator (422), a compressor (423), a condenser (424), a thermostatic expansion valve (425); a second loop (432) which can provide a cooling system for the hydrogen fuel cell system (414) and which can include a reservoir (433) and a pump (434); a third loop (443) which can provide a tempering system for the rechargeable power source (404) and which can include a reservoir (444), a heater (445), a pump (446); a fourth loop (454) which can provide a cooling system for the charger (395) and a charging cable (397) of the fast DC charging interface (396b)].

The thermal management system can further be an air tempering system which can include fans (451) for cooling the power transfer for a first swappable rechargeable power source (401a); (452) for cooling the wireless charging interface (396a); (453) for cooling the second swappable rechargeable power sources (401b). All the loops (421, 432, 443, 454) can use the same heat exchanger (458). The system can be controlled by a controller (464) which can optimalize loads, charging times, thermal management, which can perform controlling and monitoring functions and which can provide a communication interface and communicate with the vessels (403, 413) directly [e.g. via a wireless Local Area Network] and/or the system can be controlled by a central controller (466) which can communicate with the onboard controller (464) [e.g. via a satellite connection].

FIG. 26 is a schematic side view of another embodiment of a marine rechargeable power source (474) provided in an offshore charging system comprising water vessels at least partially electrically driven (483, 493) and a mobile buoyant container (472) [e.g. a hull] shaped to convene to the water vessels (483, 493), a source management system which can comprise a wireless charger (476), a DC charger (477), a DC charger (487) for second swappable rechargeable power sources (484) provided by the MPS (474), another DC charger (497) for a rechargeable power source (494) comprised by the MPS (474) which can comprise a power generator (504) [which can be a motor generator] and another MPS power source management system (514) which can be coupled with a charging cable (513) with an offshore power source (512) [e.g. a (smart) grid].

The MPS (474) can provide a thermal management system which can be a liquid tempering system which can include loops [a first loop (521) which can cool the wireless charger (476); a second loop (522) which can cool the wired charger (477); a third loop (523) which can include a heater (not shown) and which can temper the second swappable rechargeable power sources (484); a fourth loop (524) which can include a heater (not shown) and which can temper the rechargeable power source (494); a fifth loop (525) which can cool the motor generator (504) and a sixth loop (526) which can cool the MPS power source management system (514) and the charging cable (513). All the loops (521 to 526) can be provided with a respective heat exchanger (531 to 536) which can provide a heat exchange with an offshore water (478). The system can be controlled by an onboard controller (475) which can optimalize loads, charging times, cell thermal management and balancing, etc.

FIG. 27 is a schematic side view of a thermal management system of a wireless charging interface (546) which can be provided on a surface of a container (542) of a marine rechargeable power source (not shown) which can be used in the proposed system. An MPS can provide a thermal management system which can be an air cooling module which can include a fan (541) to cool the interface (546) when charging an electric vessel (543).

FIG. 28 is a perspective illustration of a thermal management system of a wireless charging interface (556) which can be used in the proposed offshore charging system. An MPS (not shown) can provide a thermal management system which can be a liquid tempering system comprising a pump (554), a heat exchanger (552) in a thermal contact with an offshore water (558) to cool the interface (556) when charging an electric vessel (553).

FIG. 29 is a schematic of a thermal management system of a charging cable (563) which can be used in the proposed offshore charging system. Charging wires (561) can be provided with a watertight protective shock insulation layer (562) [which can be made of a thermally conductive material] and with a cooling layer (564) which can include coolant conducts. The surface layer (562) can be corrugated, finned, etc. to enlarge the cooling area of air/liquid cooling.

FIG. 30a is a schematic of a first step (S571) of an offshore swapping method, the step of bringing by water vessels at least partially electrically driven (583a, 583b) first marine rechargeable power sources (581a, 581b)—one buoyant (581a) and the other nonbuoyant (581b) [which both can comprise a conveniently shaped container and a payment terminal (not shown)]—within an operational range of an onshore swapping place (585) which can comprise a charging apparatus (585a) which can charge and/or discharge the first marine rechargeable power sources (581a, 581b) and which can be coupled with an offshore wind energy to electric energy converter (586). The swapping place (585) can be situated in an offshore water (589).

FIG. 30b is a schematic of a second step (S572) of the offshore swapping method shown in FIG. 30a, the step of swapping the first marine rechargeable power sources (581a, 581b) for second marine rechargeable power sources (582a, 582b)—one buoyant (582a) and the other nonbuoyant (582b) [which both can comprise a conveniently shaped container and a payment terminal (not shown)]—provided by the onshore swapping place (585) which can comprise the charging apparatus (585a) which can charge and/or discharge the first marine rechargeable power sources (581a, 581b) and/or the second marine rechargeable power sources (582a, 582b) and which can be coupled with onshore arrays of solar cells (587).

FIG. 30c is a schematic of a third step (S573) of the offshore swapping method shown in FIGS. 30a and 30b, the step of transferring power between the second marine rechargeable power sources (582a, 582b) and the water vessels at least partially electrically driven (583a, 583b) while in a motion (584a, 584b) [or stationary] in the offshore water (589). The onshore swapping place (585) can comprise the charging apparatus (585a) which can be coupled with an onshore power source (588) [which can be a power grid and/or a motor generator].

FIG. 31a is a schematic of a first step (S601) of an offshore swapping method, the step of bringing by water vessels at least partially electrically driven (613a, 613b) first marine rechargeable power sources (611a, 611b)—one buoyant (611a) and the other nonbuoyant (611b) [which both can comprise a conveniently shaped container (not shown)]—within an operational range of an offshore swapping place (615) which can be situated in an offshore water (619).

FIG. 31b is a schematic of a second step (S602) of the offshore swapping method shown in FIG. 31a, the step of swapping the first marine rechargeable power sources (611a, 611b) for second marine rechargeable power sources (612a, 612b)—one buoyant (612a) and the other nonbuoyant (612b) [which both can comprise a conveniently shaped container (not shown)]—provided by the offshore swapping place (615) in the offshore water (619).

FIG. 31c is a schematic of a third step (S603) of the offshore swapping method shown in FIGS. 31a and 31b, the step of transferring power between the second marine rechargeable power sources (612a, 612b) and the water vessels at least partially electrically driven (613a, 613b) while in a motion (614a, 614b) [or stationary] in the offshore water (619).

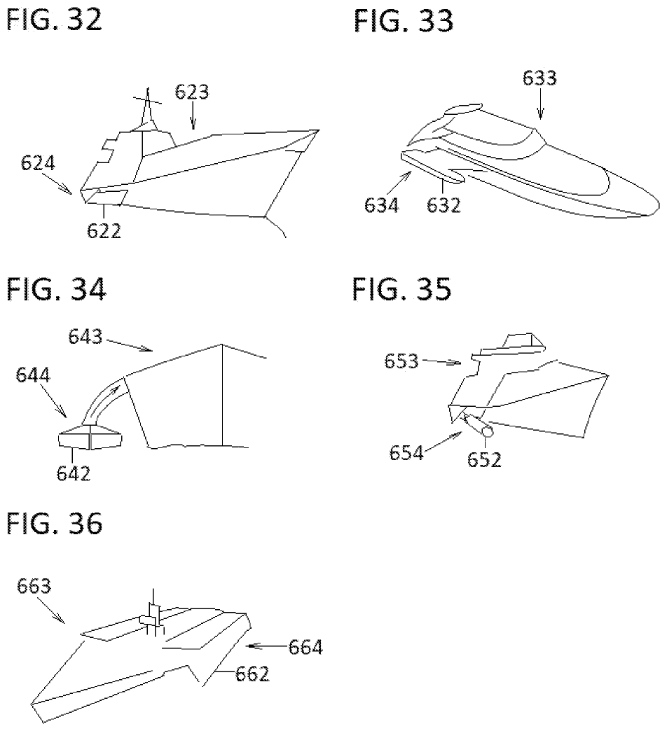

FIG. 32 is a schematic perspective view of another embodiment of a marine rechargeable power source (624) comprising a mobile buoyant container (622) which can be shaped to convene to a water vessel at least partially electrically driven (623) [which can be a Navy's combat ship].

FIG. 33 is a schematic perspective view of another embodiment of a marine rechargeable power source (634) comprising a mobile buoyant container (632) which can be shaped to convene to a water vessel at least partially electrically driven (633) [which can be a cruising yacht].

FIG. 34 is a schematic frontal view of another embodiment of a marine rechargeable power source (644) comprising a mobile buoyant container (642) which can be shaped to convene to a water vessel at least partially electrically driven (643) [which can be a merchant ship]. The container (642) can be detachably coupled with the ship (643) by means of a lateral beam which can provide mechanical, electrical and electronic connections.

FIG. 35 is a schematic perspective view of another embodiment of a marine rechargeable power source (654) comprising a mobile buoyant container (652) which can be shaped [e.g. can be a releasable torpedo type] to convene to a water vessel at least partially electrically driven (653) [which can be a Navy's combat ship].

FIG. 36 is a schematic perspective view of another embodiment of a marine rechargeable power source (664) comprising a mobile buoyant container (662) which can be shaped to convene to a water vessel at least partially electrically driven (663) [which can be a Navy's aircraft carrier; the rechargeable power source (664) can provide power to the ship (663) and/or to the aircrafts (not shown)].

Common Requirements

Marine power source systems (MPSs) situated in seas or in oceans [e.g. afloat at a swapping place] may be object of various tidal ranges varying from near zero to about 16 metres (53.5 feet) and averaging about 0.6 metres (2 feet) in the open ocean. In that case, anchorage systems of anchored (moored) MPSs may be designed to cope with a tidal range in a selected area for placement of the MPS (e.g. sliding systems, slack-line anchorage systems, etc.).

The MPSs operated/temporarily operated under water level may provide atmospheric pressure in the container (e.g. filled with dry air, nitrogen, etc.) which may be advantageous for its electronic components or may be kept at another pressure.

The MPSs may further include further components enhancing their functionality such as installation spaces, connecting boxes, electricity meters, main switches, input/output terminals, fuse distributions, etc. The electronic control and communication components may be housed in electromagnetically shielded spaces. All electrical and electronical equipment may be particularly protected against moisture, salt water and grid to prevent failure of power and electronic components. External controls may be suitably adapted to function in offshore conditions. Subsea plugs, isolation bushings, cathodic protection and special resistive materials and anticorrosive surface treatments may be used.

Common Requirements on Marine Rechargeable Power Source Systems in Cold Areas

The MPSs may be provided in the Arctic, the Antarctic, subpolar and cold seas and regions. In that case, components of the MPSs may be designed to be conform with cold/extremely cold/temporarily cold conditions. Containers (mobile containers) may be specifically designed to be posed on a solid base (e.g. ice). A special insulation of power cables may be provided. A special thermal insulation of the MPSs (e.g. rechargeable power sources in containers) may be provided. A specific solutions for thermal management system components may be needed. Thermal management systems may require heating systems.

No limitations are intended others than as described in the claims. The present invention is not limited to the described exemplary embodiments. It should be noted that various modifications of the MPS can be made without departing from the scope of the invention as defined by the claims.

The elements described in this specification and the used terminology reflect the state of knowledge at the time of the filling of this application and may be developed in the future.

### INDUSTRIAL APPLICABILITY

The present invention may provide a marine rechargeable power source system (MPS) for water vessels at least partially electrically driven which may increase operational ranges of the vessels and reduce the necessary on-board battery capacity.

Conveniently shaped buoyant or nonbuoyant containers may accomodate to water vessels' possibilities and may become the least possible hindering element to their opperation.

Buoyant MPSs may take advantage of buoyancy to spare loading capacity of the water vessels at least partially electrically driven.

The MPS in a cloud-based communication system may bring efficiency, flexibility, lower costs and lower CO₂ emissions to an MPS management.

Systems using renewable sources (arrays of solar cells, wind energy to electric energy converters, wave energy to electric energy converters, water currents energy to electric energy converters, tidal energy to electric energy converters) may provide a power reserve to be used for electricity production and supply by the MPS (e.g. in peak load times) or may be a principal power source.

The proposed modularity may concern all elements of the MPS and may bring functional and financial benefits to the parties. Modular designs may use various degrees of modularity [e.g. component slottability, platform systems, holistic approach, etc.]. Modules may be catalogued.

The proposed offshore swapping method using MPSs according to the invention may increase operational ranges of the water vessels at least partially electrically driven and may save time otherwise necessary for charging.

I claim:

1. A marine rechargeable power source system for a water vessel at least partially electrically driven comprising: a rechargeable power source; a source management system to manage charging and/or discharging said rechargeable power source; a power transfer interface to transfer power to and/or from said rechargeable power source; a buoyant or nonbuoyant container containing at least said rechargeable power source, characterised in that: said container is shaped to convene to said water vessel at least partially electrically driven.

2. The marine rechargeable power source according to claim 1, wherein said marine rechargeable power source further comprises a thermal management system to thermally manage said rechargeable power source and/or said power transfer interface and/or said power cable, wherein at least one said thermal management system is selected from the group consisting of air tempering systems, liquid tempering systems, liquid tempering systems using offshore water as a thermal medium, or combinations thereof.

3. The marine rechargeable power source according to claim 1, wherein said marine rechargeable power source further comprises or is at least coupled with a power source to charge and/or discharge said rechargeable power source, wherein at least one said power source is selected from the group consisting of onshore power sources, offshore power sources, arrays of solar cells, fuel cells, wind energy to electric energy converters, wave energy to electric energy converters, water currents energy to electric energy converters, tidal energy to electric energy converters, motor generators, smart grids, or combinations thereof.

4. The marine rechargeable power source according to claim 1, wherein said marine rechargeable power source further comprises a mobility device providing said container with mobility, wherein at least one said mobility device is selected from the group consisting of mobile containers, mobile buoyant containers, or combinations thereof.

5. The marine rechargeable power source according to claim 1, wherein it further comprises or is at least coupled with a payment terminal enabling at least one payment selected from the group consisting of online payments, cash payments, mobile payments, chip card payments, magnetic stripe card payments, or combinations thereof, wherein an acceptation of said payment via said payment terminal is in relation with charging and/or discharging said water vessel at least partially electrically driven and/or with a power transfer between said water vessel at least partially electricall driven and said rechargeable power source.

6. The marine rechargeable power source according to claim 1, wherein said marine rechargeable power source is provided as part of an offshore charging system characterised in that it comprises: said water vessel at least temporarily coupled to said power transfer interface.

7. The marine rechargeable power source according to claim 1, characterised in that it provides at least one data transmission selected from the group consisting of wired data transmissions, wireless data transmissions, or combinations thereof, wherein said data transmission is in relation with charging and/or discharging said rechargeable power source and/or said water vessel at least partially electrically driven and/or with a power transfer between said water vessel and said rechargeable power source.

8. The marine rechargeable power source according to claim 1, wherein said marine rechargeable power source is provided as part of a cloud-based communication system, characterised in that it comprises: one or more communication nodes, wherein at least one said communication node is selected from the group consisting of operators, said marine rechargeable power sources, said water vessels at least partially electrically driven, or combinations thereof; a cloud, wherein said communication node is in wired and/or wireless communication with said cloud.

9. The marine rechargeable power source according to claim 1, wherein said marine rechargeable power source is provided as part of a modular system, characterised in that it comprises: a module, wherein at least one said module is selected from the group consisting of said rechargeable power sources, said source management systems, said containers, power transfer interfaces, power cables, thermal management systems, arrays of solar cells, fuel cells, wind energy to electric energy converters, wave energy to electric energy converters, water currents energy to electric energy converters, tidal energy to electric energy converters, motor generators, payment terminals, mobility devices, hydrogen production systems, hydrogen storage systems, fuel dispensers, fuel storage sysems, fuelling line systems, or combinations thereof, wherein said module is modularly scalable and/or exchangeable and/or couplable with at least one element of said marine rechargeable power source.

10. An offshore swapping method, the method comprising the steps of:
taking to a swapping place by a water vessel at least partially electrically driven a first marine rechargeable power source comprising: a rechargeable power source; a source management system to manage charging and/or discharging said rechargeable power source; a power transfer interface to transfer power to and/or from said rechargeable power source; a buoyant or nonbuoyant container containing at least said rechargeable power source, wherein said container is shaped to convene to said water vessel at least partially electrically driven;
swapping said first marine rechargeable power source for a second marine rechargeable power source provided by said swapping place.

11. The offshore swapping method according to claim 10, further comprising the step of: transferring power between said marine rechargeable power source and said water vessel at least partially electrically driven at least partially while said water vessel at least partially electrically driven be stationary or in a motion.

12. The offshore swapping method according to claim 10, wherein said first marine rechargeable power source and/or said second marine rechargeable power source further comprise or are at least coupled with a payment terminal enabling at least one payment selected from the group consisting of online payments, cash payments, mobile payments, chip card payments, magnetic stripe card payments, or combinations thereof, wherein an acceptation of said payment via said payment terminal is in relation with charging and/or discharging said water vessel at least partially electrically driven and/or with a power transfer between said water vessel at least partially electricall driven and said rechargeable power source.

13. The offshore swapping method according to claim 10, wherein said swapping place comprises one or more charging apparatuses to charge and/or discharge said first marine rechargeable power source and/or said second marine rechargeable power source.

14. The offshore swapping method according to claim 10, wherein said swapping place further comprises or is at least coupled with a power source to charge and/or discharge said first marine rechargeable power source and/or said second marine rechargeable power source, wherein at least one said power source is selected from the group consisting of onshore power sources, offshore power sources, arrays of solar cells, fuel cells, wind energy to electric energy converters, wave energy to electric energy converters, water currents energy to electric energy converters, tidal energy to electric energy converters, motor generators, smart grids, or combinations thereof.
